(19) United States
(12) Patent Application Publication
(10) Pub. No.: US 2024/0310183 A1
(43) Pub. Date: Sep. 19, 2024

(54) PARKING LOT GUIDANCE APPARATUS, SYSTEM, METHOD AND COMPUTER READABLE MEDIUM

(71) Applicant: NEC CORPORATION, Tokyo (JP)

(72) Inventors: Tetsuro Hasegawa, Tokyo (JP); Kazuki OGATA, Tokyo (JP); kei YANAGISAWA, Tokyo (JP); Hiroaki AMINAKA, Tokyo (JP); Kosei KOBAYASHI, Tokyo (JP)

(73) Assignee: NEC Corporation, Minato-ku, Tokyo (JP)

(21) Appl. No.: 18/278,696

(22) PCT Filed: Mar. 30, 2021
(86) PCT No.: PCT/JP2021/013432

§ 371 Date: Aug. 24, 2023

(51) Int. Cl. G01C 21/36; G06V 20/58; H04W 4/40

(52) U.S. Cl. CPC G01C 21/3685; G06V 20/58; H04W 4/40

(57) ABSTRACT

Congestion determination means determines whether or not a road near an entrance of a first parking lot for which the vehicle is heading is congested based on sensor information output by a sensor. Selection means selects, from among one or more parking lots different from the first parking lot, a second parking lot to which the vehicle is to be guided when the congestion determination means determines that the road is congested. Notification means notifies the vehicle of the second parking lot.

### TECHNICAL FIELD

The present disclosure relates to a parking lot guidance apparatus, system, method, and a computer readable medium.

### BACKGROUND ART

As a related technique, Patent Literature 1 discloses a parking assistance apparatus. The parking assistance apparatus described in Patent Literature 1 detects whether or not there are vehicles waiting to be parked in a full parking lot. When there are vehicles waiting to be parked, the parking assistance apparatus detects whether or not there are vacant parking spaces in one or more neighboring parking lots adjacent to the full parking lot. The parking assistance apparatus outputs guidance information that prompts the vehicle to park in the neighboring parking lot with the vacant parking space. The parking assistance apparatus also reserves the vacant parking space and outputs information about the parking space reserved for the vehicle. Patent Literature 2 describes another related technique.

### CITATION LIST

### Patent Literature

Patent Literature 1: International Patent Publication No. WO2006/109828
Patent Literature 2: Japanese Unexamined Patent Application Publication No. 2000-113393

### SUMMARY OF INVENTION

### Technical Problem

Here, even if the parking lot is not full, the entrance to the parking lot may become a bottleneck and the road near the entrance may become congested. In Patent Literature 1, vehicles are guided to the neighboring parking lot when the parking lot is full and there are vehicles waiting to be parked. Therefore, in Patent Literature 1, users are not guided to a neighboring parking lot when the parking lot is not full.

In view of the above circumstances, an object of the present disclosure is to provide a parking lot guidance apparatus, system, method, and a computer readable media that can guide a user to a parking lot that he/she can smoothly enter.

### Solution to Problem

In order to achieve the above object, the present disclosure provides a parking lot guidance apparatus as a first example aspect. The parking lot guidance apparatus includes: congestion determination means for determining whether or not a road near an entrance of a first parking lot for which the vehicle is heading is congested based on sensor information output by a sensor; selection means for selecting, from among one or more parking lots different from the first parking lot, a second parking lot to which the vehicle is to be guided when the congestion determination means determines that the road is congested; and notification means for notifying the vehicle of the second parking lot.

The present disclosure provides a parking lot guidance system as a second example aspect. The parking lot guidance system includes: a sensor configured to output sensor information; and a parking lot guidance apparatus configured to guide a vehicle heading for a first parking lot to a parking lot. The parking lot guidance apparatus includes: congestion determination means for determining whether or not a road near an entrance of the first parking lot for which the vehicle is heading is congested based on the sensor information output by the sensor; selection means for selecting, from among one or more parking lots different from the first parking lot, a second parking lot to which the vehicle is to be guided when the congestion determination means determines that the road is congested; and notification means for notifying the vehicle of the second parking lot.

The present disclosure provides a parking lot guidance method as a third example aspect. The parking lot guidance method includes: determining whether or not a road near an entrance of a first parking lot for which the vehicle is heading is congested based on sensor information output by a sensor; selecting, from among one or more parking lots different from the first parking lot, a second parking lot to which the vehicle is to be guided when it is determined that the road is congested; and notifying the vehicle of the second parking lot.

The present disclosure provides a computer readable medium as a fourth example aspect. The non-transitory computer readable medium storing a program for causing a computer to execute processing of: determining whether or not a road near an entrance of a first parking lot for which the vehicle is heading is congested based on sensor information output by a sensor; selecting, from among one or more parking lots different from the first parking lot, a second parking lot to which the vehicle is to be guided when it is determined that the road is congested; and notifying the vehicle of the second parking lot.

### Advantageous Effects of Invention

A parking lot guidance apparatus, system, method, and a computer readable media according to the present disclosure can guide a user to a parking lot that he/she can smoothly enter.

### BRIEF DESCRIPTION OF DRAWINGS

FIG. 1 is a block diagram schematically showing a parking lot guidance system according to the present disclosure;

FIG. 2 is a block diagram showing a parking lot guidance system according to an example embodiment of the present disclosure;

FIG. 3 is a block diagram showing an example of a configuration of a parking lot guidance apparatus;

FIG. 4 is a schematic diagram showing an example of a positional relationship between a plurality of parking lots;

FIG. 5 is a flowchart showing an operation procedure in the parking lot guidance apparatus; and

FIG. 6 is a block diagram showing an example of a configuration of a computer apparatus.

### EXAMPLE EMBODIMENT

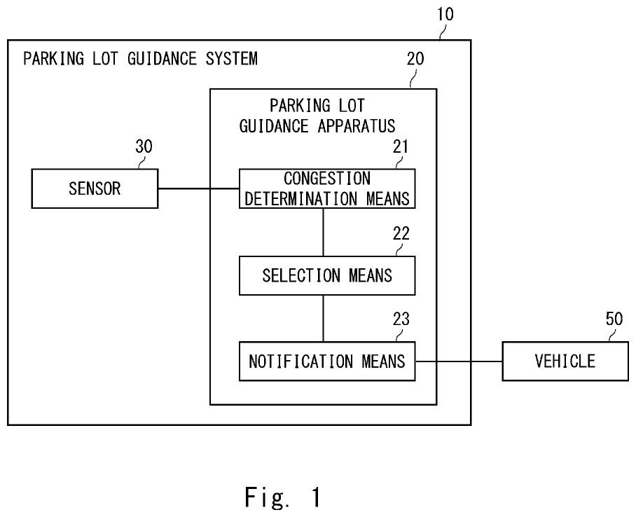

An overview of the present disclosure is provided prior to the description of an example embodiment of the disclosure. FIG. 1 schematically shows a parking lot guidance system according to the present disclosure. A parking lot guidance system 10 has a parking lot guidance apparatus 20 and a sensor 30. The sensor 30 outputs sensor information. The parking lot guidance apparatus 20 guides a vehicle heading for a first parking lot to a parking lot.

The parking lot guidance apparatus 20 has a congestion determination means 21, selection means 22, and notification means 23. Based on the sensor information output by the sensor 30, the congestion determination means 21 determines whether or not a road near an entrance of the first parking lot for which the vehicle 50 is heading is congested. When the congestion determination means 21 determines that the road is congested, the selection means 22 selects, from among one or more parking lots different from the first parking lot, the second parking lot to which the vehicle is to be guided. The notification means 23 notifies the vehicle of the selected second parking lot.

In the present disclosure, the selection means 22 selects the second parking lot as an alternative to the first parking lot if it is determined that the road near the entrance of the first parking lot for which the vehicle 50 is heading is congested. In the present disclosure, the parking lot guidance apparatus 20 can notify a vehicle of, for example, another parking lot in the neighborhood when an area near the entrance of the bottleneck parking lot is congested. Therefore, the parking lot guidance apparatus 20 can guide the user to the parking lot where the user can enter smoothly.

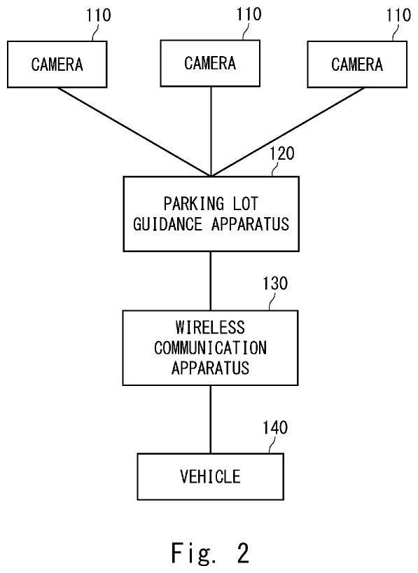

An example embodiment of the present disclosure is described in detail below. FIG. 2 shows the parking lot guidance system according to an example embodiment of the present disclosure. The parking lot guidance system 100 has cameras 110, a parking lot guidance apparatus 120, and a wireless communication apparatus 130. In FIG. 2, an example in which the parking lot guidance system 100 including three cameras 110 is shown. However, the parking lot guidance system 100 only needs to include at least one camera 110, and the number of cameras 110 is not limited to three.

The parking lot guidance apparatus 120 guides the vehicle 140 heading for the first parking lot to the parking lot. The first parking lot may be, for example, a parking lot closest to the commercial facility among a plurality of parking lots associated with the commercial facility. For example, the plurality of parking lots associated with the commercial facility include a parking lot where customers can enter the commercial facility (building) without crossing a street and a neighboring parking lot located a short distance from the commercial facility. In that case, the first parking lot may be a parking lot where customers can enter the commercial facility without crossing a street. The parking lot guidance apparatus 120 may be installed, for example, in a commercial facility and operated by an operator of the commercial facility. The parking lot guidance apparatus 120 corresponds to the parking lot guidance apparatus 20 shown in FIG. 1.

Each of the cameras (imaging apparatuses) 110 is a sensor used to acquire road conditions. The cameras 110 are positioned so that, for example, roads leading to respective entrances of the plurality of parking lots associated with the commercial facility can be photographed. The photographing range of each of the cameras 110 may include the entrance of the first parking lot. Each of the cameras 110 is disposed in on-road equipment such as traffic lights. The cameras 110 output photographed videos (video data) as sensor information. The parking lot guidance apparatus 120 acquires the videos photographed by the cameras 110 via a wireless communication network or a network such as the Internet (not shown). The cameras 110 correspond to the sensor 30 shown in FIG. 1. Other sensors may be used instead of the cameras 110.

The wireless communication apparatus (communication apparatus) 130 is configured as an apparatus that performs wireless communication with the vehicle 140. The wireless communication apparatus 130 may be a roadside unit (RSU) installed at each intersection, for example, in association with a traffic light. The wireless communication apparatus 130 may be a communication apparatus constituting a wireless communication network using a communication line standard such as LTE (Long Term Evolution). Alternatively, the wireless communication apparatus 130 may be an apparatus constituting a wireless communication network such as WiFi (registered trademark) or a 5th generation mobile communication system (5G: 5th generation). The wireless communication apparatus 130 may also be an apparatus constituting a wireless communication network of a 6th generation mobile communication system and later generation mobile communication systems. The vehicle 140 corresponds to the vehicle 50 shown in FIG. 1.

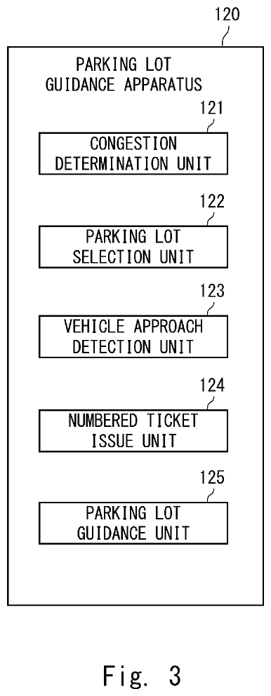

FIG. 3 shows an example of a configuration of the parking lot guidance apparatus 120. The parking lot guidance apparatus 120 has a congestion determination unit 121, a parking lot selection unit 122, a vehicle approach detection unit 123, a numbered ticket issue unit 124, and a parking lot guidance unit 125. At least a part of the function of each unit in the parking lot guidance apparatus 120 can be implemented in a computer apparatus having a processor and a memory by the processor operating in accordance with a program read from the memory.

The congestion determination unit 121 acquires videos from the cameras 110 (see FIG. 2). Using the videos acquired from the cameras 110, the congestion determination unit 121 determines whether or not the road near the entrance of the first parking lot is congested. Here, being near the entrance of the first parking lot means, for example, being in an area within a predetermined distance from the entrance of the first parking lot. Alternatively, being near the entrance of the first parking lot may mean being in a predetermined section on the road leading to the entrance of the first parking lot, including the entrance of the first parking lot. The predetermined section may be a section on a front side of the entrance as seen from the vehicle 140 traveling toward the first parking lot.

The congestion determination unit 121 determines whether or not the road near the entrance of the first parking lot is congested by, for example, performing image analysis on the video acquired from the camera 110. The congestion determination unit 121 analyzes, for example, the number of vehicles present on the road near the entrance of the first parking lot and an average speed. If the number of vehicles is greater than or equal to a threshold and the average speed is less than or equal to a predetermined speed, the congestion determination unit 121 determines that vehicles are stuck on the road near the entrance of the first parking lot and determines that the road is congested. The congestion determination unit 121 corresponds to the congestion determination means 21 shown in FIG. 1.

When the congestion determination unit 121 determines that the road is congested, the parking lot selection unit 122 selects from among one or more parking lots different from the first parking lot the second parking lot to which the vehicle 140 is to be guided. The parking lot selection unit 122 selects the second parking lot, for example, from among a plurality of other available parking lots for the commercial facility associated with the first parking lot.

The parking lot selection unit 122 may select, from among the plurality of parking lots, for example, a parking lot having an entrance at a position along a direction in which the vehicle 140 travels, as the second parking lot. Alternatively, the parking lot selection unit 122 may select, from among the plurality of parking lots, a parking lot where the vehicle 140 can enter without crossing the opposite lane, as the second parking lot. That is, the parking lot selection unit 122 may select, from among the plurality of parking lots, a parking lot having an entrance on a side of a lane where the vehicle 140 is scheduled to travel, as the second parking lot. The parking lot selection unit 122 may select, from among the plurality of parking lots, a parking lot where the vehicle 140 can enter without turning around, as the second parking lot. The parking lot selection unit 122 corresponds to the selection means 22 shown in FIG. 1.

The vehicle approach detection unit (approach detection means) 123 detects that the vehicle 140 has approached the first parking lot. When it is detected that the vehicle 140 has approached the first parking lot, the congestion determination unit 121 may determine whether or not the road near the entrance of the first parking lot is congested. When it is detected that the vehicle 140 has approached the first parking lot, and when the congestion determination unit 121 determines that the road is congested, the parking lot selection unit 122 may select the second parking lot.

Alternatively, the congestion determination unit 121 may determine whether or not the road near the entrance of the first parking lot is congested when the vehicle 140 has passed a point serving as a predetermined checkpoint having a predetermined positional relationship with the entrance of the first parking lot. The congestion determination unit 121 may determine whether or not the road near the entrance of the first parking lot is congested regardless of the position of the vehicle 140. The parking lot selection unit 122 may check whether or not the road is determined to be congested by the congestion determination unit 121 when the vehicle 140 passes the predetermined checkpoint, and select the second parking lot when it is determined to be congested.

The numbered ticket issue unit (numbered ticket issue means) 124 issues a numbered ticket for the vehicle 140 to enter the second parking lot. The numbered ticket issue unit 124 issues the numbered ticket electronically to the vehicle 140, for example, via wireless communication. The numbered ticket issue unit 124 issues an electronic numbered ticket to the vehicle 140 traveling on the road, for example, from the wireless communication apparatus 130 (see FIG. 2) installed in the on-road equipment such as traffic lights. Vehicles that have been issued the numbered tickets will be given priority access to the second parking lot. By issuing the numbered ticket of the second parking lot to the vehicle 140, the vehicle 140 can be guided to the second parking lot. The numbered ticket issue unit 124 may be omitted.

When the parking lot selection unit 122 selects the second parking lot, the parking lot guidance unit 125 notifies the vehicle 140 of the selected second parking lot. The parking lot guidance unit 125 notifies the vehicle 140 of the second parking lot, for example, via the wireless communication apparatus 130. The parking lot guidance unit 125 notifies the vehicle 140 of, for example, the position of the second parking lot. The parking lot guidance unit 125 may transmit route information to the second parking lot to the vehicle 140. In that case, the parking lot guidance unit 125 may present the vehicle 140 with a route to bypass the congested road near the entrance of the first parking lot and guide the vehicle 140 to the second parking lot. The parking lot guidance unit 125 corresponds to the notification unit 24 shown in FIG. 1.

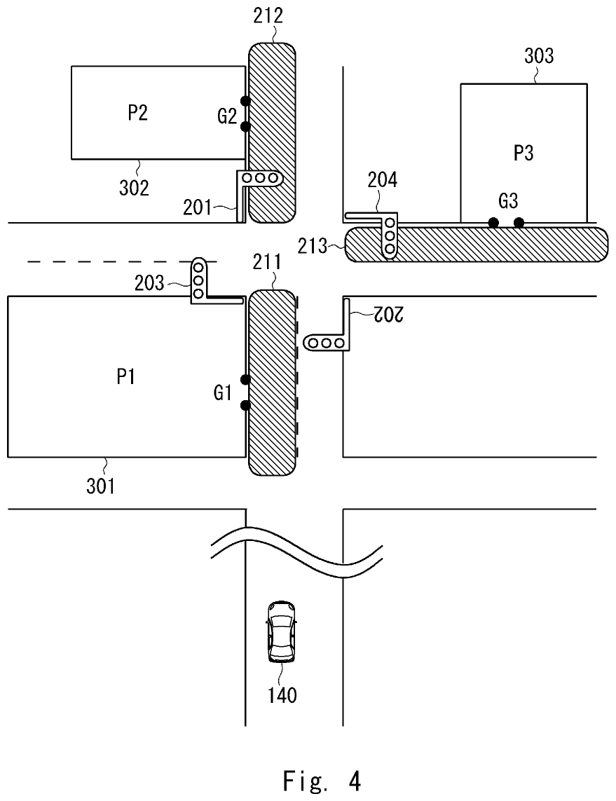

FIG. 4 shows a positional relationship between the plurality of parking lots. FIG. 4 shows three parking lots 301 to 303 as parking lots associated with the commercial facility. In FIG. 4, it is assumed that each of four traffic lights 201 to 204 installed at an intersection has at least one camera 110 (see FIG. 2). The camera installed in at least one of the traffic lights 201 and 202 shall photograph a predetermined region 211 of a road leading to an entrance G1 of the parking lot 301 and a predetermined region 212 of a road leading to an entrance G2 of the parking lot 302. The camera installed in at least one of the traffic lights 203 and 204 shall photograph a predetermined region 213 of a road leading to an entrance G3 of the parking lot 303.

In FIG. 4, it is assumed that the vehicle 140 is heading toward the parking lot 301. In other words, it is assumed that the parking lot 301 is the first parking lot. The congestion determination unit 121 acquires a congestion status (degree of congestion) of the predetermined region 211 near the entrance G1 of the parking lot 301 using the video of the camera installed in the traffic light 201 or 202. The congestion determination unit 121 also acquires a congestion status of the predetermined region 212 near the entrance G2 of the parking lot 302 and a congestion status of the predetermined region 213 near the entrance G3 of the parking lot 303. When the degree of congestion in the predetermined region 211 is greater than a threshold, the congestion determination unit 121 determines that the road near the entrance G1 of the parking lot 301 is congested.

When it is determined that the predetermined region 211 in the vicinity of the entrance G1 is congested, the parking lot selection unit 122 selects the parking lot 302 or 303 as the second parking lot. The parking lot selection unit 122 may select the parking lot 302 or 303 as the second parking lot according to the congestion status of the predetermined region 212 near the entrance G2 of the parking lot 302 and the congestion status of the predetermined region 213 near the entrance G3 of the parking lot 303. Note that, if the first parking lot for which the vehicle 140 is heading is the parking lot 302, the parking lot 302 is the first parking lot and the parking lot 301 or 303 is selected as the second parking lot. If the parking lot for which the vehicle 140 is initially heading is the parking lot 303, the parking lot 303 is the first parking lot and the parking lot 301 or 302 is selected as the second parking lot.

It is assumed that the parking lot selection unit 122 selects the parking lot 302 as the second parking lot. The parking lot guidance unit 125 notifies the vehicle 140 of the parking lot 302 as an alternative parking lot to the parking lot 301. The parking lot guidance unit 125 may retrieve the position of the vehicle 140 in the wireless communication network and notify the vehicle of the parking lot 302 from the wireless communication apparatus 130 installed at the intersection where the vehicle 140 passes. The parking lot guidance unit 125 may present the vehicle 140 with a route to the entrance G2 of the parking lot 302 that does not pass through the predetermined region 211 near the entrance G1 of the parking lot 301. If a driver of the vehicle 140 follows the route to the parking lot 302, the vehicle 140 can reach the parking lot 302 without traveling the congested road near the entrance G1 of the parking lot 301.

The numbered ticket issue unit 124 issues an electronic numbered ticket for the parking lot 302 to the vehicle 140 (to its on-vehicle apparatus) if the user so desires. The vehicle 140 receives the electronic numbered ticket from the wireless communication apparatus 130 (see FIG. 2) installed in the traffic signal, for example, at an intersection on the way to the parking lot 301. The electronic numbered ticket may include information specifying, for example, a time period during which the vehicle 140 may enter the parking lot 302. The vehicle 140 that has been issued the electronic numbered ticket may enter the parking lot 302 preferentially during the specified time period even when the parking lot 302 is congested.

Although not shown in FIG. 4, each parking lot may have a dedicated gate where vehicles with numbered tickets can enter preferentially. Vehicles with numbered tickets may enter the parking lot through the dedicated gate that is different from an entrance gate used by general vehicles. In this case, the vehicles with the numbered tickets may enter the parking lot preferentially through the dedicated gate, even if vehicles are waiting to enter at the regular entrance gate.

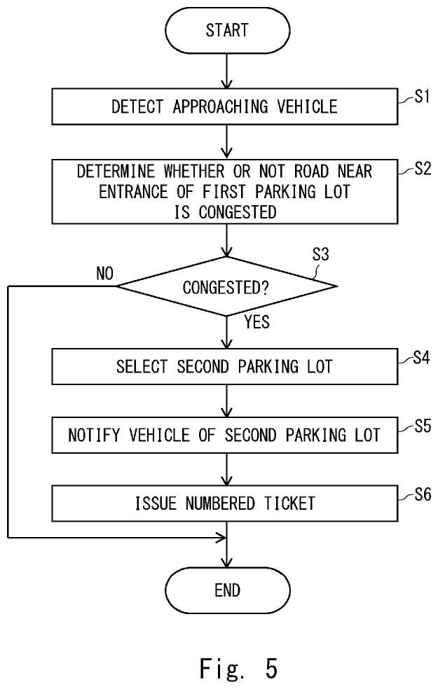

Next, an operating procedure is explained. FIG. 5 shows the operating procedure (parking lot guidance method) in the parking lot guidance apparatus 120. The vehicle approach detection unit 123 detects that the vehicle 140 is approaching the first parking lot (Step S1). The congestion determination unit 121 acquires a video from the camera 110 and determines whether or not the road near the entrance of the first parking lot is congested (Step S2). The parking lot selection unit 122 determines whether or not the road near the entrance is determined to be congested in Step S1 (Step S3). If it is determined in Step S2 that the road near the entrance is not congested, the vehicle 140 may head for the first parking lot and the processing is ended. Alternatively, the parking lot guidance apparatus 120 may notify the vehicle 140 that the road near the entrance of the first parking lot is not congested.

If it is determined in Step S2 that the road near the entrance is congested, the parking lot selection unit 122 selects, from among one or more parking lots different from the first parking lot, the second parking lot to which the vehicle is to be guided (Step S4). In Step S4, the parking lot selection unit 122 selects the second parking lot as an alternative to the first parking lot in the neighborhood of the first parking lot. The parking lot guidance unit 125 notifies the vehicle 140 of the second parking lot selected in Step S4 (Step S5). The numbered ticket issue unit 124 issues an electronic numbered ticket of the second parking lot to the vehicle 140 if the user desires (Step S6).

In this example embodiment, the congestion determination unit 121 determines whether or not the road near the entrance of the first parking lot is congested. When it is determined that the road near the entrance of the first parking lot is congested, the parking lot selection unit 122 selects a parking lot different from the first parking lot as the second parking lot. The parking lot guidance unit 125 notifies the vehicle 140 of the selected second parking lot. In this way, the parking lot guidance unit 120 can guide the vehicle 140 to the second parking lot near the first parking lot when the area near the entrance of the bottleneck parking lot is congested. Therefore, in this example embodiment, the parking lot guidance unit 120 can guide the user to the parking lot where the user can enter smoothly.

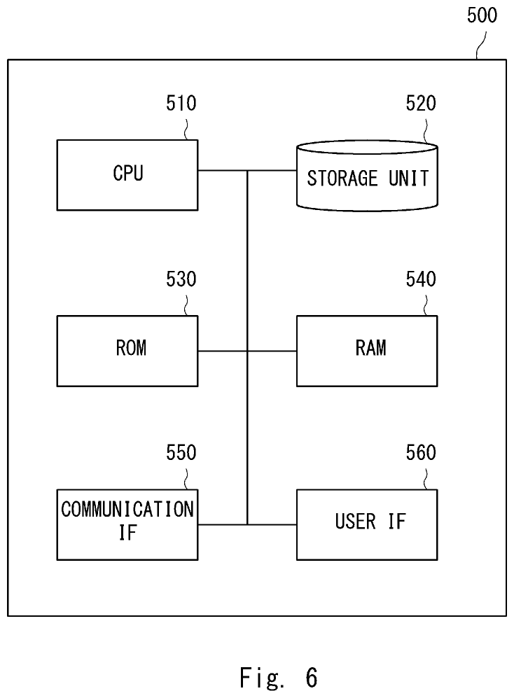

In the present disclosure, the parking lot guidance apparatus 120 can be configured as a computer apparatus (server apparatus). FIG. 6 shows an example of the configuration of the computer apparatus that can be used as the parking lot guidance apparatus 120. A computer apparatus 500 has a control unit (CPU: Central Processing Unit) 510, a storage unit 520, a Read Only Memory (ROM) 530, a Random Access Memory (RAM) 540, a communication interface (IF: Interface) 550, and a user interface 560.

The communication interface 550 is an interface for connecting the computer apparatus 500 to a communication network via wired communication means or wireless communication means. The user interface 560 includes a display unit such as a display. The user interface 560 also includes an input unit such as a keyboard, mouse, and touch panel.

The storage unit 520 is an auxiliary storage device that can hold various kinds of data. The storage unit 520 does not necessarily have to be part of the computer apparatus 500, and instead may be an external storage device or a cloud storage device connected to the computer apparatus 500 via a network.

The ROM 530 is a non-volatile storage device. For the ROM 530, a semiconductor storage device such as a flash memory with a relatively small capacity is used. The program executed by the CPU 510 can be stored in the storage unit 520 or the ROM 530. The storage unit 520 or the ROM 530 stores various programs, for example, for implementing the functions of each unit in the parking lot guidance apparatus 120.

In the above example, the program can be stored and provided to the computer apparatus 500 using any type of non-transitory computer readable media. Non-transitory computer readable media include any type of tangible storage media. Examples of non-transitory computer readable media include magnetic storage media, optical magnetic storage media, and semiconductor memories. The magnetic storage media may be floppy disks, magnetic tapes, hard disk drives, etc. The optical magnetic storage media include storage media such as magneto-optical disk. The magneto-optical disks include disk media such as CD (compact disc), DVD (digital versatile disk). The semiconductor memories may be mask ROM, PROM (Programmable ROM), EPROM (Erasable PROM), flash ROM, RAM, etc. The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The RAM 540 is a volatile storage device. Various semiconductor memory devices such as DRAM (Dynamic Random Access Memory) or SRAM (Static Random Access Memory) are used for the RAM 540. The RAM 540 can be used as an internal buffer for temporarily storing data and the like. The CPU 510 deploys the program stored in the storage unit 520 or the ROM 530 to the RAM 540 and executes it. When the CPU 510 executes the program, the function of each unit in the parking lot guidance apparatus 120 can be implemented. The CPU 510 may have an internal buffer that can temporarily store data, etc.

Although the example embodiment of the present disclosure has been described in detail above, the present disclosure is not limited to the above-described example embodiment, and changes and modifications that are made to the above-described embodiment without departing from the scope of the present disclosure are also included in the present disclosure.

The whole or part of the example embodiment disclosed above can be described as, but not limited to, the following supplementary notes.

### [Supplementary Note 1]

A parking lot guidance apparatus including:
congestion determination means for determining whether or not a road near an entrance of a first parking lot for which the vehicle is heading is congested based on sensor information output by a sensor;
selection means for selecting, from among one or more parking lots different from the first parking lot, a second parking lot to which the vehicle is to be guided when the congestion determination means determines that the road is congested; and
notification means for notifying the vehicle of the second parking lot.

### [Supplementary Note 2]

The Parking Lot Guidance Apparatus According to Supplementary Note 1, wherein the notification means guides the vehicle to the second parking lot by presenting the vehicle with a route to bypass the road near the entrance of the first parking lot.

### [Supplementary Note 3]

The Parking Lot Guidance Apparatus According to Supplementary Note 1 or 2, wherein the selection means selects, from among the one or more parking lots, a parking lot having an entrance at a position along a direction in which the vehicle travels as the second parking lot.

### [Supplementary Note 4]

The parking lot guidance apparatus according to any one of supplementary notes 1 to 3, wherein the selection means selects, from among the one or more parking lots, a parking lot having an entrance on a side of a lane where the vehicle is scheduled to travel as the second parking lot.

### [Supplementary Note 5]

The parking lot guidance apparatus according to any one of supplementary notes 1 to 4, wherein the selection means selects, from among the one or more parking lots, a parking lot where the vehicle can enter without turning around as the second parking lot.

### [Supplementary Note 6]

The parking lot guidance apparatus according to any one of supplementary notes 1 to 5, further including numbered ticket issue means for issuing a numbered ticket to the vehicle for entering the second parking lot.

### [Supplementary Note 7]

The parking lot guidance apparatus according to supplementary note 6, wherein the numbered ticket issue means issues the numbered ticket electronically to the vehicle via wireless communication.

### [Supplementary Note 8]

The parking lot guidance apparatus according to supplementary note 7, wherein the numbered ticket issue means transmits the electronically issued numbered ticket to the vehicle from a communication apparatus installed in on-road equipment provided on a road where the vehicle travels.

### [Supplementary Note 9]

The parking lot guidance apparatus according to any one of supplementary notes 1 to 7, further includes approach detection means for detecting that the vehicle has approached the first parking lot, wherein
the selection means selects, from among the one or more parking lots different from the first parking lot, the second parking lot when the approach detection means detects that the vehicle has approached the first parking lot and the congestion determination means determines that the road is congested.

### [Supplementary Note 10]

The parking lot guidance apparatus according to any one of supplementary notes 1 to 9, wherein
the sensor includes an imaging apparatus whose imaging range includes the entrance of the first parking lot, and
the congestion determination means determines whether or not the road near the entrance of the first parking lot is congested using the video photographed using the imaging apparatus.

### [Supplementary Note 11]

A parking lot guidance system including:
a sensor configured to output sensor information; and
a parking lot guidance apparatus configured to guide a vehicle heading for a first parking lot to a parking lot, wherein
the parking lot guidance apparatus includes:
   congestion determination means for determining whether or not a road near an entrance of the first parking lot for which the vehicle is heading is congested based on the sensor information output by the sensor;
   selection means for selecting, from among one or more parking lots different from the first parking lot, a second parking lot to which the vehicle is to be guided when the congestion determination means determines that the road is congested; and
   notification means for notifying the vehicle of the second parking lot.

### [Supplementary Note 12]

The parking lot guidance system according to supplementary note 11, wherein the notification means guides the vehicle to the second parking lot by presenting the vehicle with a route to bypass the road near the entrance of the first parking lot.

### [Supplementary Note 13]

The parking lot guidance apparatus according to supplementary note 11 or 12, wherein the parking lot guidance apparatus further includes numbered ticket issue means for issuing a numbered ticket to the vehicle for entering the second parking lot.

### [Supplementary Note 14]

The parking lot guidance system according to supplementary note 13, further including a communication apparatus installed in on-road equipment provided on a road where the vehicle travels, wherein
the numbered ticket issue means transmits the electronically issued numbered ticket to the vehicle from the communication apparatus.

### [Supplementary Note 15]

The parking lot guidance apparatus according to any one of supplementary notes 11 to 14, wherein
the sensor includes an imaging apparatus whose imaging range includes the entrance of the first parking lot, and
the congestion determination means determines whether or not the road near the entrance of the first parking lot is congested using the video photographed using the imaging apparatus.

### [Supplementary Note 16]

A parking lot guidance method including:
determining whether or not a road near an entrance of a first parking lot for which the vehicle is heading is congested based on sensor information output by a sensor;
selecting, from among one or more parking lots different from the first parking lot, a second parking lot to which the vehicle is to be guided when it is determined that the road is congested; and
notifying the vehicle of the second parking lot.

### [Supplementary Note 17]

A non-transitory computer readable medium storing a program for causing a computer to execute processing of:
determining whether or not a road near an entrance of a first parking lot for which the vehicle is heading is congested based on sensor information output by a sensor;
selecting, from among one or more parking lots different from the first parking lot, a second parking lot to which the vehicle is to be guided when it is determined that the road is congested; and
notifying the vehicle of the second parking lot.

### REFERENCE SIGNS LIST

10: PARKING LOT GUIDANCE SYSTEM
20: PARKING LOT GUIDANCE APPARATUS
21: CONGESTION DETERMINATION MEANS
22: SELECTION MEANS
23: NOTIFICATION MEANS
30: SENSOR
50: VEHICLE
100: PARKING LOT GUIDANCE SYSTEM
110: CAMERA
120: PARKING LOT GUIDANCE APPARATUS
121: CONGESTION DETERMINATION UNIT
122: PARKING LOT SELECTION UNIT
123: VEHICLE APPROACH DETECTION UNIT
124: NUMBERED TICKET ISSUE UNIT
125: PARKING LOT GUIDANCE UNIT
130: WIRELESS COMMUNICATION APPARATUS
140: VEHICLE
201-204: TRAFFIC SIGNAL
301-303: PARKING LOT
211-213: PREDETERMINED REGION
500: COMPUTER APPARATUS
510: CPU
520: STORAGE UNIT
530: ROM
540: RAM
550: COMMUNICATION INTERFACE
560: USER INTERFACE

What is claimed is:

1. A parking lot guidance apparatus comprising:
a memory storing instructions; and
a processor configured to execute the instructions to:
determine whether or not a road near an entrance of a first parking lot for which the vehicle is heading is congested based on sensor information output by a sensor;
select, from among one or more parking lots different from the first parking lot, a second parking lot to which the vehicle is to be guided when it is determined determines that the road is congested; and
notify the vehicle of the second parking lot.

2. The parking lot guidance apparatus according to claim 1, wherein the processor is configured to execute the instructions to guide the vehicle to the second parking lot by presenting the vehicle with a route to bypass the road near the entrance of the first parking lot.

3. The parking lot guidance apparatus according to claim 1, wherein the processor is configured to execute the instructions to select, from among the one or more parking lots, a parking lot having an entrance at a position along a direction in which the vehicle travels as the second parking lot.

4. The parking lot guidance apparatus according to claim 1, wherein the processor is configured to execute the instructions to select, from among the one or more parking lots, a parking lot having an entrance on a side of a lane where the vehicle is scheduled to travel as the second parking lot.

5. The parking lot guidance apparatus according to claim 1, wherein the processor is configured to execute the instructions to select, from among the one or more parking lots, a parking lot where the vehicle can enter without turning around as the second parking lot.

6. The parking lot guidance apparatus according to claim 1, the processor is further configured to execute the instructions to issue a numbered ticket to the vehicle for entering the second parking lot.

7. The parking lot guidance apparatus according to claim 6, wherein the processor is configured to execute the instructions to issue the numbered ticket electronically to the vehicle via wireless communication.

8. The parking lot guidance apparatus according to claim 7, wherein the processor is configured to execute the instructions to transmit the electronically issued numbered ticket to the vehicle from a communication apparatus installed in on-road equipment provided on a road where the vehicle travels.

9. The parking lot guidance apparatus according to claim 1, the processor is further configured to execute the instructions to detect that the vehicle has approached the first parking lot, wherein
the processor is configured to execute the instructions to select, from among the one or more parking lots different from the first parking lot, the second parking lot when it is detected that the vehicle has approached the first parking lot and it is determined that the road is congested.

10. The parking lot guidance apparatus according to claim 1, wherein
the sensor includes an imaging apparatus whose imaging range includes the entrance of the first parking lot, and
the processor is configured to execute the instructions to determine whether or not the road near the entrance of the first parking lot is congested using the video photographed using the imaging apparatus.

11. A parking lot guidance system comprising:
a sensor configured to output sensor information; and
the parking lot guidance apparatus according to claim 1.

12. The parking lot guidance system according to claim 11, wherein the processor is configured to execute the instructions to guide the vehicle to the second parking lot by presenting the vehicle with a route to bypass the road near the entrance of the first parking lot.

13. The parking lot guidance apparatus according to claim 11, wherein the processor is further configured to execute the instructions to issue a numbered ticket to the vehicle for entering the second parking lot.

14. The parking lot guidance system according to claim 13, further comprising a communication apparatus installed in on-road equipment provided on a road where the vehicle travels, wherein
the processor is configured to execute the instructions to transmit the electronically issued numbered ticket to the vehicle from the communication apparatus.

15. The parking lot guidance apparatus according to claim 11, wherein
the sensor includes an imaging apparatus whose imaging range includes the entrance of the first parking lot, and
the processor is configured to execute the instructions to determine whether or not the road near the entrance of the first parking lot is congested using the video photographed using the imaging apparatus.

16. A parking lot guidance method comprising:
determining whether or not a road near an entrance of a first parking lot for which the vehicle is heading is congested based on sensor information output by a sensor;
selecting, from among one or more parking lots different from the first parking lot, a second parking lot to which the vehicle is to be guided when it is determined that the road is congested; and
notifying the vehicle of the second parking lot.

17. A non-transitory computer readable medium storing a program for causing a computer to execute processing of:
determining whether or not a road near an entrance of a first parking lot for which the vehicle is heading is congested based on sensor information output by a sensor;
selecting, from among one or more parking lots different from the first parking lot, a second parking lot to which the vehicle is to be guided when it is determined that the road is congested; and
notifying the vehicle of the second parking lot.
